(19) United States
(12) Patent Application Publication
(10) Pub. No.: US 2008/0127113 A1
(43) Pub. Date: May 29, 2008

(54) METHOD AND SYSTEM FOR IMPLEMENTING WATCHPOINTS

(75) Inventors: Zhou Wu, Beijing (CN); Dang En Ren, Beijing (CN); Hong Bo Peng, Beijing (CN); Jiang Dong Sun, Beijing (CN)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/944,703

(22) Filed: Nov. 26, 2007

(30) Foreign Application Priority Data
Nov. 27, 2006 (CN) 2006-10146881.3

(51) Int. Cl. G06F 9/44

(52) U.S. Cl. 717/129

(57) ABSTRACT

A method and system for implementing watchpoints used in debugging a computer program includes: during the compilation phase of the program, generating the access location information for the variables in the program through data flow analysis; and during the debugging phase of the program, implementing the watchpoint for a program variable as specified by the user according to the access location information for the program variable. The access location information may be generated from DU chains or UD chains for the variables. The implementing step may set the watchpoint by setting a breakpoint at each of the locations in the access location information for the specified variable and marking the breakpoint as bound to the specified program variable, and by triggering the watchpoint when a breakpoint marked as bound to the specified program variable is hit.

### FIELD OF THE INVENTION

The present invention relates to the computer field, and specifically to the technology of debugging computer programs, and more specifically to a method and system for implementing watchpoints used in debugging computer programs.

### BACKGROUND

Debugging is an important phase in the development of software. In this phase, developers would spend a lot of time and use various debugging methods and techniques to find the source of program faults and correct them. Watchpoints are one of the critical techniques used in the debugging process. Watchpoints are notifications presented to the debugger when a specified portion of the address space of the program being debugged is accessed. A watchpoint “watches” an address range in the memory space of the program being debugged, and is triggered whenever any attempt to access the address range occurs, that is, stops the program being debugged.

Developers use watchpoints to monitor accesses, including read accesses and write access, to specified variables or expressions in the program in order to find whether there occurs any unexpected situation. They can expose many serious programming faults such as, for example, unexpected accesses to program variables, and program errors in relation to timing, such as asynchronous accesses, program errors in multi-thread accesses.

Current debuggers may have some kinds of support for watchpoints. However, the current techniques have some drawbacks.

The first kind of watchpoints is based on hardware facilities provided by processors. The most direct approach of this implementation is to provide special base/limit registers for specifying a starting address and a run length in the processor. Then it is the responsibility of the processor to capture any modification attempt to the data in this address range, and stop the processor before the writing occurs. Such watchpoints are fast to implement, but they depend on processors, therefore are not a general solution. Different processors support watchpoints in different ways. Some processors do not support watchpoints at all. Besides, hardware facilities are expensive, because available hardware resources are always limited. When all the available hardware facilities are used up, the debugger would have to switch to a software implementation of watchpoints.

U.S. Pat. No. 6,829,701 B2, “Watchpoint Engine for a Pipelined Processor,” proposes a watchpoint mechanism specifically for multi-phase pipelined processors. These watchpoints can monitor the passage of the effects of instruction execution in the multi-phase pipeline. Its implementation is achieved by some extra integrated circuits called watchpoint engines. As such, this patent requires hardware to provide an extra support, and relies on specific processors, and therefore is not a general solution for implementing watchpoints.

Software mechanisms supporting watchpoints may use stepwise simulation, which works as follows: if any watchpoint is set, the program will execute stepwise. That is, after the execution of each machine instruction of the program being debugged, the program will be stopped, and control will be given to the debugger. Then the debugger will evaluate all the watched variables to see whether they have changed. If there is any variable changed, it will be known that a write watchpoint hit has occurred on the variable. The advantage of this method is its generality and independence of any platform. But it is very slow. After the execution of each instruction, the program being debugged will be stopped, and the debugger will obtain the control. Most of such context switches would not find any watchpoint hit. The costs of these context switches are very high. Moreover, this mechanism does not support read watchpoints, which are also very useful. Another kind of watchpoint mechanism is by changing the paging mechanism. For an example of this mechanism, reference can be made to the U.S. Pat. No. 7,047,520 B2, entitled “Computer System with Watchpoint Support”, and published on May 16, 2006. This method is realized by changing the attributes of system pages. In particular, if a user sets a watchpoint on a variable (or an address), the attributes of the system page containing the variable (or address) will be modified. Thus, when this memory page is accessed, a page access exception will be triggered. After the debugger intercept the page access exception, a piece of newly-added code in the debugger will detect whether this access indeed occurred on the variable (or address) being watched. If it did, indicating the watchpoint event has been triggered, the debugger will give control to the user; if it did not, a normal page operation will be restored, and the program will proceed to execute.

Compared with the above stepwise simulation method, this method is more efficient. However, it has the disadvantages of all paging methods. Firstly, it watches a whole page, which is much larger than what the user intends to watch, a variable, thus some unnecessary interrupts would be generated, and the performance would be affected. Secondly, since this patent needs to modify the page attributes of the program being debugged, this will need the support of the kernel; and the debugger in the user space needs to judge on its own whether each generated exception interrupt really occurred on the variable address being watched. Moreover, since page accesses are frequent operations, the extra code will increase the complexity of page management, and the efficiency of page management will also be decreased.

Thus, there is a need in the art for a method and system for implementing watchpoints in a general and efficient way, which can overcome the above and other disadvantages of the current watchpoint implementation techniques.

### SUMMARY

The present invention enhances the compiler to reuse its data flow analysis capabilities, so as to obtain all the access location information of any program variable, and then sets breakpoints at the access locations of the variable in debugging to perform the functions of watchpoints.

According to an aspect of the present invention, there is provided a method for implementing watchpoints used in debugging a computer program, the method comprising the steps of: during the compilation phase of the program, generating the access location information for the variables in the program through data flow analysis; and during the debugging phase of the program, implementing watchpoints for program variables as specified by the user according to the access location information for the program variables.

According to another aspect of the present invention, there is provided a method for generating the binary code file of a program having the access location information of the variables in the program which can be used for debugging from the source program through a compiler, the method comprising the steps of: generating a read access instruction set and a write access instruction set in an intermediate representation for each variable in the program based on the results of data flow analysis; during the code generation phase, updating the read access instruction set and write access instruction set to be a corresponding binary read access location set and a write access location set; and writing the binary read access location set and write access location set into the binary code file of the program.

According to yet another aspect of the present invention, there is provided a method for setting and triggering watchpoints in the binary code file of a program as generated through the above method by a debugger, the method comprising the steps of: reading the binary read access location set and write access location set for a program variable as specified by the user; setting a breakpoint at each access location in the read access location set and write access location set, and marking the breakpoint as bound to the specified variable; and when a breakpoint is detected by the debugger, determining whether the breakpoint is bound to any specified program variable; and when the determination is YES, notifying the user that the watchpoint on the variable specified by the user was hit.

According to still another aspect of the present invention, there is a system for implementing watchpoints used in debugging a computer program, the system comprising: a generation apparatus on the compiler side for generating the access location information for the variables in the program through data flow analysis; and an implementing apparatus on the debugger side for implementing watchpoints for program variables as specified by the user according to the access location information for the program variables.

According to another aspect of the present invention, there is provided a compiler configured for generating the binary code file of a program having the access location information for the variables in the program which can be used for debugging from the source program, the compiler comprising: a generation module for generating a read access instruction set and a write access instruction set in an intermediate representation for each variable in the program based on the results of the data flow analysis of the program; an updating module for updating the read access instruction set and write access instruction set to be a corresponding binary read access location set and a write access location set during the code generation phase; and a writing-into-binary-code-file module for writing the binary read access location set and write access location set into the binary code file of the program.

According to another aspect of the present invention, there is provided a debugger configured to debug the binary code file of a program as generated by the above compiler, the debugger comprising: a reading module for reading the binary read access location set and write access location set for a program variable as specified by the user; a setting module for setting a breakpoint at each access location in the read access location set and write access location set, and marking the breakpoint as bound to the specified variable; and a determination module for determining, when a breakpoint hit is detected by the debugger, whether the breakpoint is bound to any specified program variable, and for notifying the user that the watchpoint on the specified variable was hit when the determination is YES.

In addition, the present invention can also be embodied in a computer readable medium storing thereon a computer program product comprising instruction for implementing any method of the preceding method claims.

The solution of the present invention can overcome shortcomings of the prior art. Briefly, it is general, efficient and independent of processors.

If only the compiler can output the required access information of each variable, the debugger can easily use this information to monitor accesses to the variable. This solution does not require any change to the underlying operating system. It does not need hardware support, and therefore is independent of hardware platforms. It would stop the execution of the program only at the point where the variable on which a watchpoint has been set is to be accessed, therefore it is much faster than other software implementations.

It can also permit compiler optimization in some way. That is, even if there is any optimization of the variable accesses, whether it is instruction re-ordering, register allocation or any other optimization measures, provided only the compiler can generate the corresponding instruction address information for the variable, the debugger can watch it easily.

### BRIEF DESCRIPTION OF THE DRAWINGS

The present invention and its embodiments will be better understood by reference to the following detailed description of illustrative embodiments when read in conjunction with the accompanying drawings, in which:

FIG. 1 is a schematic diagram illustrating the working process of a typical compiler;

FIG. 2 is a schematic diagram illustrating the changes to a current compiler according to an embodiment of the present invention;

FIG. 3 is a schematic flow diagram illustrating the process on the compiler side of a method for implementing watchpoints according to an embodiment of the present invention;

FIG. 4 is schematic flow diagram of the process performed on the debugger side of a method for implementing watchpoints according to an embodiment of the present invention;

FIG. 5 is a diagram illustrating the read access location list and write access location list of a variable generated according to an embodiment of the present invention;

FIG. 6 is a diagram illustrating the correspondence relationships between a watchpoint variable and the breakpoints set at multiple locations for it; and

FIG. 7 is a block diagram illustrating a system for implementing watchpoints according to an embodiment of the present invention.

### DETAILED DESCRIPTION

A compiler may be used to translate source code written in a high level language into executable binary code, generating an executable program. A debugger may be used to detect and debug the executable program generated by the compiler, in order to find and correct errors in the program. The debugger relies on the compiler to function, because the information generated by the compiler, such as the source and line formation, call frame information, etc., can be utilized by the debugger. The compiler and the debugger often reside in the same IDE to facilitate the development and debugging of programs. Of course, the two can also be independent of each other.

The present invention uses the data flow analysis capability of the compiler. Data flow analysis is a static analysis technique, which can automatically collect information such as the dependence between data items in the program by analysis of the computer source program code or its intermediary representation. The collected information can generally be used for optimization of the program, and for this reason, most compilers include one or more data flow analysis phases. Data flow analysis can provide the global information about how the program manipulates or accesses its variables. This information enables the compiler to know the way in which the program accesses its data, and therefore may be used in data-related compiler optimizations such as dead store elimination, constant propagation, etc. However, this information can also be used for the watchpoint function, because watchpoints are also related to accesses to program variables. In various embodiments of the invention, the debugger may reuse the results of data flow analysis to support watchpoints.

According to an embodiment of the present invention, data structures of the information on variable accesses as generated by data flow analysis, such as DU chains (or UD chains), are extended to record all the accesses (reads or writes) to all the program variables. A DU chain comprises the definition of a variable and all the uses reachable from the definition without any other intermediary definitions. A definition generally means the assignment of a value to the variable.

According to an embodiment of the present invention, on the compiler side, two sets are generated for each variable based on the DU chains (or UD chains) of the variable as generated in the data flow analysis phase, one is called read access set for all the read access instructions for the variable, the other is called write access set for all the write instructions for the variable. The members of each of the sets are the addresses of these instructions.

According to an embodiment of the present invention, on the debugger side, the above read access set and write access set of each variable as generated on the compiler side are read, and a breakpoint is set at each access address for the variable for which a watchpoint needs to be set, thereby implementing a watchpoint for the variable.

In the following, changes to the compiler and debugger according to embodiments of the present invention, and a method and system for implementing watchpoints according to embodiments of the present invention will be described in detail.

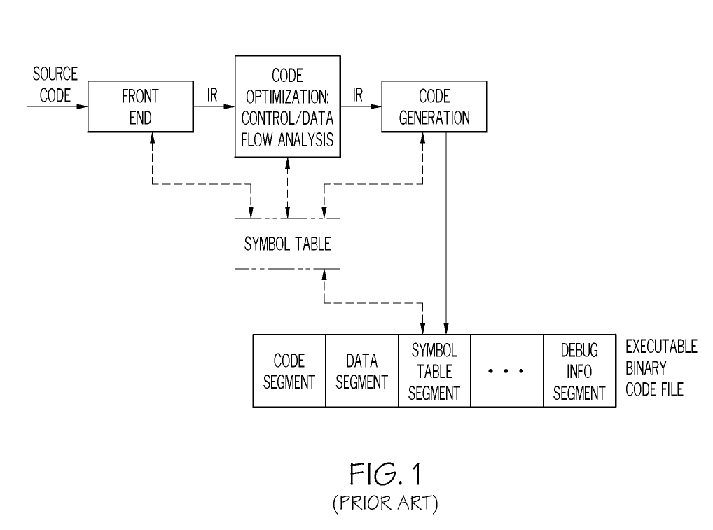

Changes on the compiler side according to embodiments of the present invention: FIG. 1 schematically illustrates the working process of a typical compiler. With reference to FIG. 1, the compiler is used to translate the source code into executable binary code, and the translation process typically comprises several phases or passes. Firstly, the compiler needs to do some preprocessing, performing lexical and syntactical analysis, which is called the front end. Thereafter, the source code will be translated into some intermediary representation (IR), which will permit the data flow analysis and rearrangement of the program. What follows is the code optimization phase, which is used to optimize the program in the intermediary representation according to the results of the data flow analysis. And finally, we have the code generation phase, which will generate executable binary code according to the optimized intermediary representation. In all of the phases, a symbol table needs to be interacted with. As known to those skilled in the art, the symbol table is a data structure used by the compiler, in which each symbol in the program source code or its intermediary representation is associated with information such as the location, type, and scope level etc. A “symbol” in the symbol table may refer to a variable, function or data type in the source code or its intermediary representation. The symbol table may either be a temporary data structure which is used only in the compiling process and then discarded, or be embedded in the output of the compiling process, such as in a binary code file, in order to be utilized later, e.g., in the debugging. Moreover, the debugger can also re-create its own symbol table based on the relevant information in the binary code file.

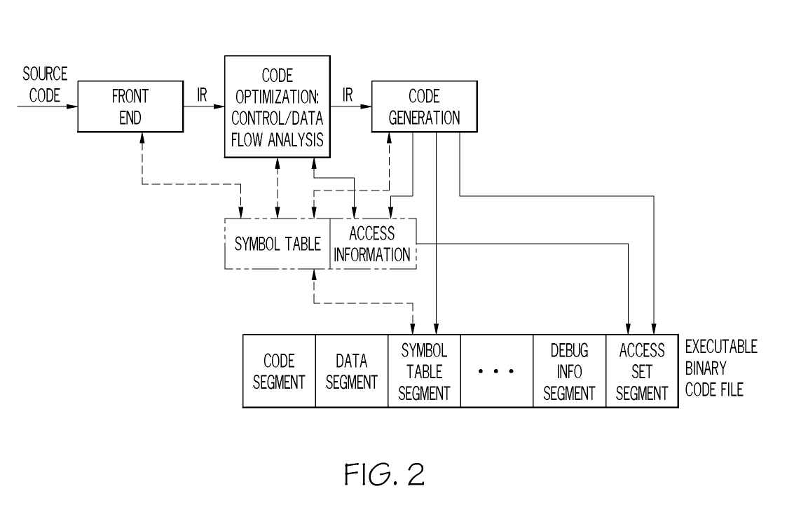

FIG. 2 schematically illustrates changes to the current compiler according to an embodiment of the present invention. As shown, some changes are made in the compiling phase of the current compiler in order for the compiler to support watchpoints. The first change is in the data flow analysis, the second change is in the code generation. At the same time, preferably, the structure of the symbol table also needs to be extended in order to include the access set information for each variable. Finally, the access set information needs to be outputted to the resultant binary code.

First, consider the data flow analysis phase, in which the compiler will generate the DU chain information for each variable. A DU chain of a variable connects the definition of the variable to all its uses, wherein the definition corresponds to a write operation, and the uses correspond to read operations. Given all the DU chains for a variable, all possible accesses to the variable can be known.

The structure of a DU chain can be expressed by a function as follows:

DU chain:(variable symbol, variable definition)−>set of variable uses

wherein, the variable definition and variable uses are the labels of their corresponding IR statements.

According to an embodiment of the present invention, at the end of this phase, a process is added, which converts all the DU chains for a variable into two sets: one is a write access set, which records all the definitions of the variable; the other is a read access set, which records all the uses of the variable. That is, these two sets represents the addresses of all the instructions that access (read or write) the specified variable. The structures of these two sets can by expressed by a function as follows:

write access set: variable symbol−>write access set for the variable

read access se: variable symbol−>read access set for the variable.

These two sets can be implemented as linked lists, and be added into the symbol table as an extension to the variable entry in the symbol table, as shown in the middle of FIG. 2. Alternatively, these two sets can also be added into another existing data structure in the compiling process, or exist as a separate data structure. In addition, these two sets can also be implemented as other data structures other than linked lists.

For example, for the following piece of code:

a:=b+c 1

b:=a−c 2

c:=a−b 3

a:=b−c 4

c:=a−2b 5

b:=a−2c. 6

Variable a has two DU chains:

(a,1)=(2,3)

(a,4)=(5,6).

The read access set and write access set generated through the conversion by the pseudocode hereinbelow are as follows:

read access set for “a”:(2,3,5,6)

write access set for “a”:(1,4).

The pseudocode for performing the conversion from DU chains to read access sets and write access sets can be expressed as follows:

```
for (all the Variable Symbols) do
  initialize write set: Write_Set[Variable_Symbol] = null
  initialize read set: Read_Set[Variable_Symbol] = null
done
for (all the DU-Chains) do
  split du-chain, get Variable_Symbol, Def_Place and
  Set_of_Use_Place
  append Def_Place into Write_Set[Variable_Symbol]
  for (each member of Set_of_Use_Place) do
    if (Use_Place is not member of Read_Set[Variable_Symbol])
      append Use_Place into Read_Set[Variable_Symbol]
    endif
  done
done
```

In another embodiment of the present invention, in stead of DU chains, UD chains are used to generate the read access set and write access set for variables. For example, for the same above piece of code, variable “a” has four UD chains:

(a,2)=(1)

(a,3)=(1)

(a,5)=(4)

(a,6)=(4).

By using conversion code similar to the above conversion code, the same read access set and write access set can be obtained:

read access set for “a”:(2,3,5,6)

write access set for “a”:(1,4).

During the code generation phase, all the IR code will be translated into machine instructions. The label for each IR code will also be translated into the final instruction address (absolute address or relocatable address). At this point, the compiler can update the access sets in the symbol table, that is, substituting binary address information for the IR labels in the access sets. The last step is to output the updated access sets into a data segment of the resultant binary code. This data segment can be an extra special segment, as shown in FIG. 2. Alternatively, the updated access sets can also be inserted into an existing segment. For example, the ELF (Executable and Linkable Format) uses a segment named .debuginfo to record the information of each variable. Each variable will be recorded as a tag with some attributes, such as the address, type, length, etc. The two sets can be appended as two extra attributes of the tag. Thus, in the resultant binary code, there will be the access set information for each variable. A debugger can use the access set information to set watchpoints.

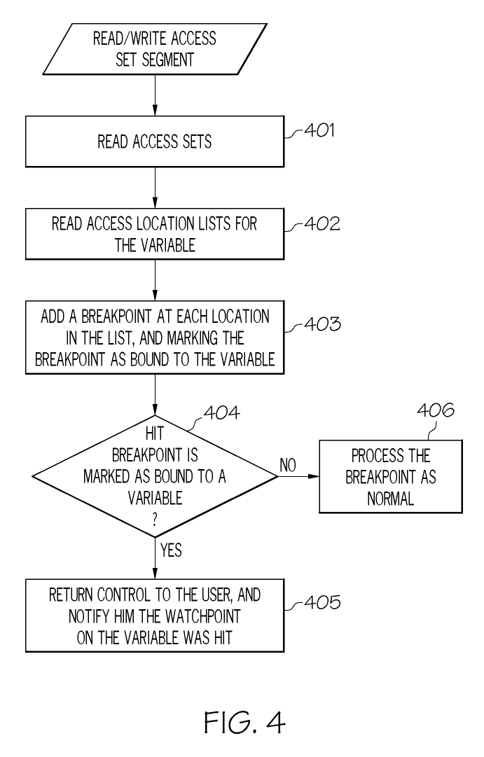

Changes on the debugger side according to embodiments of the present invention: For the debugger, firstly an extra reader should be added for reading the access sets, as shown by the program loading phase in FIG. 4. Thus, in addition to the type, address and length information of the variables, the debugger can also know which places in the program will access these variables. This information can be linked to a symbol table created by the debugger.

When the debugger is commanded to set a watchpoint (read watchpoint or write watchpoint), it can read from the symbol table the corresponding access location sets, that is, access location lists. Then, it is only needed to set breakpoints at all these locations in the lists, and mark these breakpoints as bound to the specified variable. In this way, a watchpoint can be transformed into one or more breakpoints. As known to those skilled in the art, breakpoints are intentional stop or pause positions placed in the program during the program development for the purpose of debugging. A hit on a breakpoint will cause an interrupt, enabling the programmer to check whether the program runs properly. It is the most basic function in all debuggers and at the same time can be most easily and efficiently implemented.

According to an embodiment of the present invention, when the debugger detects a hit on a breakpoint, it can read the breakpoint number from the breakpoint list maintained by itself, so as to know whether this breakpoint is marked as bound to any variable. If it is, then the breakpoint hit is actually a watchpoint hit. And the debugger may return control to the user, and notify the user that the watchpoint on the specified variable is hit.

In the following, the various steps of the method for implementing watchpoints according to embodiments of the present invention will be described in detail.

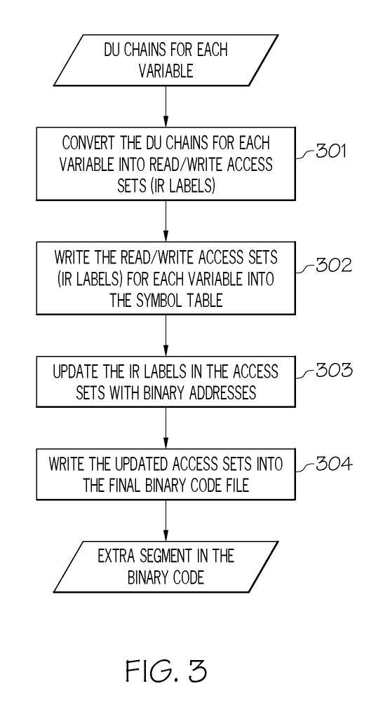

A method for implementing watchpoints according to embodiments of the present invention: FIG. 3 schematically illustrates the process flow on the compiler side of the method for implementing watchpoints according to an embodiment of the present invention.

As shown, during the data flow analysis phase of the compiling process, in step 301, the DU chains for each variable in the program to be debugged, as generated by data flow analysis, are converted into a read access set and a write access set for the variable. The members of the read access set and the write access set may be labels in an intermediary representation of the read instructions and write instructions for the variable respectively. The conversion may be performed using the algorithm of the above example, or using any other algorithm as may occur to those skilled in the art. In addition, the read access sets and writes access set for the variable may also be generated from the UD chains for each variable as generated by data flow analysis or from any other possible data structures that can represent the access information for each variable. In step 302, the read access set and write access set in the intermediary representation for each variable are written into a symbol table as part thereof. This may be accomplished by extending the data structure of an existing symbol table. In the existing symbol table, each symbol has a field indicating its type, and symbols of different types have their own additional attributes. An additional attribute of access set may be added to the symbols of variable type. After the access set information is obtained in step 301, it may be written therein directly. In another embodiment of the present invention, the read access set and the write access set may also be stored as a separate data structure, such as a ordinary linked list, or be written into another data structure generated during the data flow analysis. Whatever the case, if only the read access set and the write access set for each variable are stored in association with the symbol for the variable, these changes are all within the scope of the present invention.

Thus, according to an embodiment of the present invention, the symbol table or another data structure with the extension of the access sets is obtained.

During the code generation phase in the compiling process, the compiler maps the statements of the program in the intermediary representation into binary code, at the same time each IR label in the symbol table will also be translated into a binary instruction address. Then, in step 303, the corresponding binary addresses will be substituted for the IR labels in the access sets for each variable in the symbol table or another data structure, the IR labels representing the read instructions or write instructions for the variable.

In step 304, the updated access sets for each variable are written into the final binary code. This can be accomplished either by adding an extra access set segment in the binary code as shown in FIG. 2, and writing the access sets for each variable into the access set segment; or by writing the access sets for each variable into an existing symbol table segment, as additional attributes of each corresponding variable symbol in the symbol table segment; or by writing the access set for each variable into a file other than the binary code file of the program, which file will be provided to the debugger as an attached file during the debugging phase. Whatever the case, the access sets for each variable are linked with the symbol for the variable.

As such, according to an embodiment of the present invention, the binary code file of the program is obtained, as well as the included or attached access sets for each variable. The binary code file and the access sets for each variable can be provided to a debugger for debugging the program and for setting watchpoints according to the method of the present invention.

It is to be noted that the above description is only illustrative in nature, and should not be construed as limiting the present invention. Various changes can be made to the above process, such as some steps can be deleted, added, modified, combined, split, executed in different order or in parallel, etc., without departing from the spirit and scope of the present invention. For example, it can be contemplated that the data flow analysis be performed not on the intermediary representation of the program, but directly on the source program, to obtain the DU chains or UD chains for each variable and their read access sets and write access sets. If only the access location information for each variable can be generated from the results of the data flow analysis, all these variations are within the scope of the present invention.

FIG. 4 schematically illustrates the process flow performed on the debugger side of the method for implementing watchpoints according to an embodiment of the present invention. As shown, in the program loading phase of the debugger, in step 401, the access set location reading module may read the read access location set and write access location set, that is, the read access location list and write access location list, for each variable in the program included in or attached to the binary code file of the program and generated in the above process on the compiler side by the method for implementing watchpoints of the present invention.

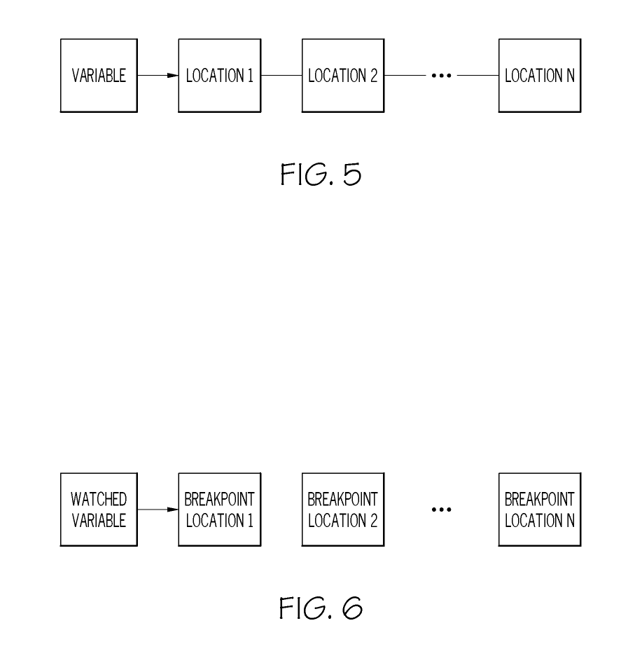

FIG. 5 illustrates the read access location list and write access location list for each variable. The read access location list and write access location list for each variable can be saved in a symbol table established by the debugger, or be saved in another existing data structure of the debugger, or be saved separately. The correspondence relationships between each variable and its read access location list and write access location list may be kept in various ways, all of which are within the scope of the present invention.

In another embodiment of the present invention, during the program loading phase of the debugger, there is no separate step 401 of reading the access location sets for each variable from the binary code file of the program, that is, during the program loading phase of the debugger, the entire binary code file with the access sets for each variable is read as usual, and the access location sets for a user specified variable will be read therefrom in the next step 402.

After the program loading process has completed, during the user command processing phase, in step 402, when the user sets a watchpoint on a variable, the access location lists for the variable will be read from the read access location lists and write access location lists generated in step 401 according to the variable for which the user sets the watchpoint. Alternatively, in case that there is no separate step 401, the access location list for the variable can be read from the loaded binary code file.

In addition, in case that the user commands only to set a read watchpoint or a write watchpoint for the variable, in step 402, only the read access location list or the write access location list for the variable can be read.

In step 403, for each location in the access location lists for the variable, a breakpoint is set at this location in the program, and the breakpoint is marked as bound to the variable. FIG. 6 schematically illustrates the correspondence relationships between a watchpoint variable and the breakpoints set at multiple locations for it. A breakpoint can be marked as bound to a variable in any way as may occur to those skilled in the art, such as by maintaining a table reflecting the correspondence relationships between breakpoints and variables.

In addition, in case that the user command only to set a read watchpoint or a write watchpoint for the variable, in step 403, a breakpoint may be set at each access location in the read access location set or at each access location in the write access location, and a flag may be set to bind the breakpoint to the variable.

When the program has set multiple breakpoint and possibly other normal breakpoints, the program is executed, thus entering the event processing phase. If, during the program execution process, the debugger detects a breakpoint is hit, it will first determine the breakpoint number of the breakpoint, and according to an embodiment of the present invention, in step 404, determine whether the breakpoint is marked as bound to a variable, for example, by looking up the above table reflecting the correspondence relationships between breakpoints and variables.

If, in step 404, it is determined that the breakpoint is marked as bound to a variable, in step 405, control may be returned to the user, and he may be notified that a watchpoint on the variable was hit, so that the user can check the execution of the program. Otherwise, in step 406, the breakpoint will be processed normally.

It is to be noted that the above description is only illustrative, and should not be construed as limiting the present invention. The above process can be changed in various ways, such as some steps may be removed, added, modified, combined, split, changed in order, or executed in parallel, without departing from the spirit and scope of the present invention. All these variations are within the scope of the present invention, provided only watchpoints can be implemented by setting breakpoints based on the access location information for program variables as generated during the compiling phase.

In another aspect of the present invention, there is further provided a method for generating a binary code file of a program with the access location information for variables in the program which can be used for debugging from the source program by a compiler, the method comprising the following steps: generating a read access instruction set and a write access instruction set in an intermediate representation for each variable in the program based on the results of data flow analysis; during the code generation phase, updating the read access instruction set and write access instruction set to be a corresponding binary read access location set and a write access location set; and writing the binary read access location set and write access location set into the binary code file of the program.

For a detailed description and illustration of the steps in the method, reference can made to the illustration of the steps on the compiler side of the method for implementing watchpoints according to an embodiment of the present invention as shown in FIG. 3 and the above corresponding detailed description.

In another aspect of the present invention, there is further provided a method for setting and triggering watchpoints in the binary code file of a program as generated through the above method by a debugger, the method comprising the following steps: reading the binary read access location set and write access location set for a program variable as specified by the user; setting a breakpoint at each access location in the read access location set and write access location set, and marking the breakpoint as bound to the specified variable; when a breakpoint is detected by the debugger, determining whether the breakpoint is bound to any specified program variable; and when the determination is YES, notifying the user that the watchpoint on the variable specified by the user was hit.

For a detailed description and illustration of the steps in the method, reference can be made to the illustration of the steps on the debugger side of the method for implementing watchpoints according to an embodiment of the present invention as shown in FIG. 4 and the above corresponding detailed description.

Next, a system for implementing watchpoints according to embodiments of the present invention will be described in detail.

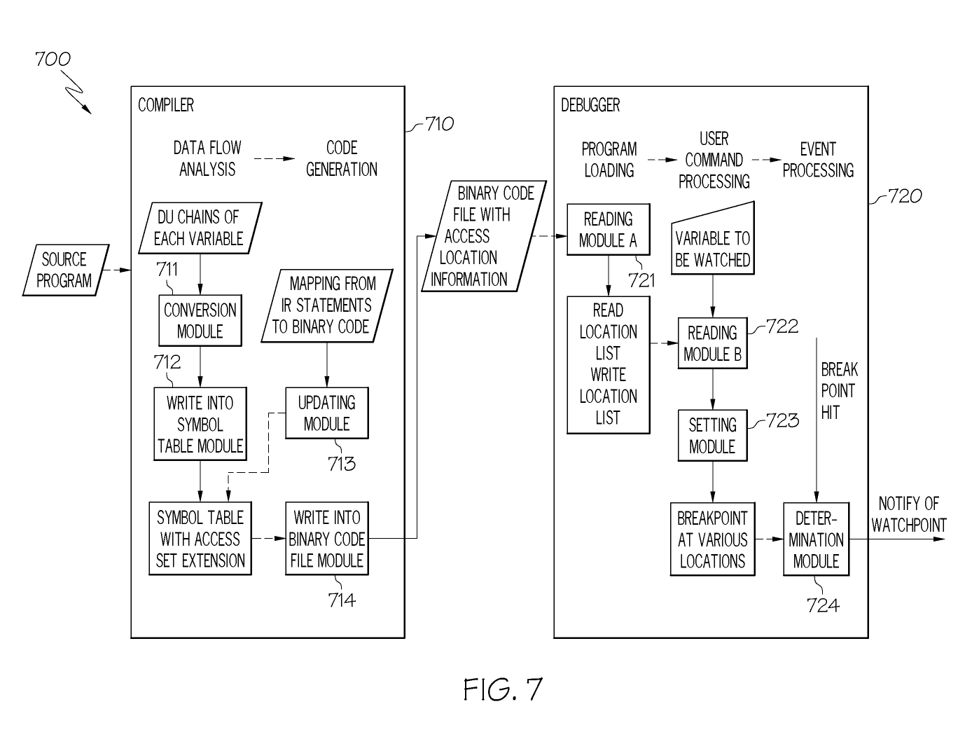

A system for implementing watchpoints according to embodiments of the present invention: FIG. 7 illustrates a system for implementing watchpoints according to an embodiment of the present invention. As shown, the system 700 for implementing watchpoints is implemented through a compiler 701 and a debugger 720, that is, the system 700 comprises a portion implemented in the compiler 710 and a portion implemented in the debugger 720. In FIG. 7, for the sake of brevity, modules in the compiler 710 and debugger 720 which are not relevant to the invention are not shown.

As shown, on the compiler 710 side, after the source program is inputted and processed by the front end (not shown) of the compiler, an intermediary implementation of the program is generated. Then, data flow analysis is performed on the intermediary representation of the program, in order to optimize the program. The DU chains (or UD chains) of each variable in the program are generated by the data flow analysis. Then, after processing by various modules on the compiler side of the system 700 for implementing watchpoints according to an embodiment of the present invention, a binary code file of the program with the access locations for each variable is finally generated, in order to be debugged by the debugger 720.

As shown, on the compiler side 710, the system 700 for implementing watchpoints according to an embodiment of the present invention comprises: a conversion module 711 for converting the DU chains in the intermediary representation of each variable in the program into a read access instruction set and a write access instruction set in the intermediary representation for the variable; a write-into-symbol-table module 712 for writing the read access instruction set and the write access instruction set in the intermediary representation into the symbol table during the code generation phase; an updating module 713 for updating the read access instruction set and the write access instruction set to be a corresponding binary read access location set and a write access location set; and a write-into-binary-code-file module 714 for writing the binary read access location set and the write access location set into the binary code file of the program. Wherein, the conversion module 711 may receive data structures of the information on variable accesses, such as DU chains or UD chains, from the data flow analysis module of an existing compiler 710. The conversion module 711 may be either an extension to an existing data flow analysis module, or a separate module outside the existing data flow analysis module.

The write-into-symbol-table module 712 may receive the generated read access instruction set and the write access instruction set for each variable from the conversion module 711 and write them into the symbol table, as an extension to the symbol table. The write-into-symbol table 712 can alternatively write the read access set and the write access set for each variable into another place outside the symbol table. The write-into-symbol-table module 712 may either be an extension to an existing data flow analysis module, or a separate module outside the existing data flow analysis module.

The updating module 713 may be either an extension to the existing code generation module of the compiler 710, or a separate module outside the existing code generation module. It may update the read access instruction set and write access instruction set stored in the symbol table or another data structure to be a corresponding binary read access location set and write access location set.

The write-into-binary-code-file module 714 may be either an extension to the existing code generation module of the compiler 710, or a separate module outside the existing code generation module. It may write the updated read access location set and the write access location set into the binary code file of the program, or write them into a separate attached file, in order to be used by the debugger. When writing the access location sets into the binary code file of the program, the write-into-code-file module 714 can write them into the symbol table segment of the binary code file as an extension thereto, or write them into a separate segment.

As shown, on the debugger side, the system 700 for implementing watchpoints according to an embodiment of the present invention comprises: a reading module A 721 for reading the read access location set and write access location set for each variable from the binary code file of the program during loading the program; a reading module B 722 for reading the corresponding read access location set and write access location set for a specified variable according to a command from the user for setting a watchpoint and the specified variable on which the watchpoint is to be set; a setting module 723 for setting a breakpoint at each access location in the read access location set and write access location set for the specified variable, and marking the breakpoint as bound to the program variable; a determination module 724 for determining, when the debugger detects a breakpoint hit, whether the breakpoint is bound to any specified program variable; and a notification module 725 for notifying the user that the watchpoint set on the program variable was hit when the determination is YES.

Wherein, the reading module A 721 may be attached to the binary program loading module of the debugger, as part thereof, for reading the read access location set and write access location set for each variable in the binary code file of the program; or it may be a separate file loading module outside the binary program loading module for reading the read access location set and write access location set for each variable stored in the attached file. The functions of the reading module A 721 may also be performed entirely by the existing binary program loading module, that is, the existing binary program loading module may load the entire binary code file including the access location sets for each variable without identifying the access location sets for each variable therein, which will be read by the reading module B 722 hereinbelow from the loaded binary code file. Thus, the system 700 of the present invention can have no separate reading module A 721.

The reading module B 722 may be attached to the user command processing module of the debugger, for processing the command to set a watchpoint and reading the corresponding access location sets for a variable based on the variable name. The reading module B 722 may be an extension to the existing user command processing module of the debugger as a part thereof, or it may be a separate module outside the existing user command processing module of the debugger. In addition, the reading module B 722 may either read the access location sets for a user specified variable from the access location sets for all variables as obtained by the reading module A 721, or, in case that the reading module A 721 does not exist, read the access location sets for the specified variable directly from the loaded binary code file of the program.

Further, in case that the user only commands to set a read watchpoint or a write watchpoint for a variable, the reading module B 722 may only read the read access location set or the write access location set for the variable.

The setting module 723 may be attached to the user command processing module as a part thereof, or be a separate module. The setting module 723 may set a breakpoint at each access location in the access location sets for the specified variable as read by the reading module B 722, and set a flag to bind the breakpoint to the variable. The setting module 723 can bind a breakpoint to a variable using any method as may occur to those skilled in the art, such as by maintaining a table reflecting the correspondence relationships between breakpoints and variables.

In addition, in case that the user only commands to set a read watchpoint or a write watchpoint for a variable, the setting module 723 can only set a breakpoint at each access location in the read access location set or at each access location in the write access location set, and set a flag to bind the breakpoint to the variable.

The reading module B 722 may also be combined with the setting module 723 as a single module for processing the user command to set a watchpoint.

The determination module 724 is a part of an event processing module of the debugger, and in particular, is a part of a breakpoint event processing module. It can be implemented by modifying the existing event processing module of the debugger, or by attachment to the existing event processing module of the debugger. When a breakpoint hit event is detected, the determination module 724 may first find the corresponding number or other relevant information of the breakpoint based on the breakpoint address, and determine whether the breakpoint is bound to a variable, for example, through the table reflecting the correspondence relationships between breakpoints and variables, as well as which variable the breakpoint is bound to, and when the determination is YES, return control to the user, and notify him that the watchpoint on the variable was hit.

It is to be noted that the above description of the system for implementing watchpoints according to an embodiment of the present invention is only illustrative and exemplary, and should not be construed as limiting the presenting invention. Some modules may be removed, modified, replaced, added, combined together, split apart, changed in linking relationships, etc., all the variations being within the scope of the present invention, provided only that the combination of the modules can implement watchpoints based on the results of data flow analysis. For example, the conversion module 711 and the write-into-symbol-table module 722 can be combined into a single module for converting the DU chains (or UD chains) of each variable in the program into the read access instruction set or write access instruction set for the variable, and for writing the access instruction sets into the symbol table. The updating module 713 and the write-into-binary-code-file 714 module can also be combined into a single module for updating the access instruction sets for each variable in an intermediary representation to be binary access location sets for the variable, and for writing the access location sets into the binary code file or a separate file of the program. The reading module A 721 and the reading module B 722 can also be combined into a single module for reading the read access location set and the write access location set for a user specified variable. In addition, the division into and names of the various modules are only for the convenience of narration and nomenclature, and should not be construed as limiting the present invention. For example, the various modules on the compiler side can be referred to together as a generation apparatus for generating the access location information for the variables in a program by data flow analysis; and the various modules on the debugger side can be referred to together as an implementation module for implementing watchpoints for user specified variables based on the access location information of the variables.

In another aspect of the present invention, there is further provided a compiler for generating the binary code file of a program having the access location information for the variables in the program which may be used for debugging from the source program. The compiler is characterized by comprising: a generation module for generating a read access instruction set and a write access instruction set in an intermediate representation for each variable in the program based on the results of the data flow analysis of the program, such as by converting the DU chains or UD chains for each variable in the program into the read access instruction set and write access instruction set for the variable in the intermediary representation; an updating module for updating the read access instruction set and write access instruction set to be a corresponding binary read access location set and a write access location set during the code generation phase; and a writing-into-binary-code-file module for writing the binary read access location set and write access location set into the binary code file of the program.

For a detailed description and illustration of the various modules in the compiler, reference can be made to the illustration of the various modules on the compiler side in the system 700 for implementing watchpoints according to embodiments of the present invention in FIG. 7 and the foregoing corresponding detailed description.

In another aspect of the present invention, there is further provided a debugger for debugging the binary code file of a program as generated by the above compiler, the debugger is characterized by comprising: a reading module for reading the binary read access location set and write access location set for a program variable as specified by the user; a setting module for setting a breakpoint at each access location in the read access location set and write access location set, and marking the breakpoint as bound to the specified variable; and a determination module for determining whether a breakpoint is bound to any specified program variable when the breakpoint is detected by the debugger, and for notifying the user that the watchpoint on the specified variable was hit when the determination is YES.

For a detailed description and illustration of the various modules in the debugger, reference can be made to the illustration of the various modules on the debugger side in the system 700 for implementing watchpoints according to embodiments of the present invention in FIG. 7 and the foregoing corresponding detailed description.

In the foregoing, a new watchpoint implementation of the present invention has been described, which is general, more efficient and platform independent, and also has a low cost. The required changes are mainly on the compiler side. It is only required to re-use current DU chain information, converting the information into access sets, and outputting the access sets into the resultant binary code. And it is also easy for a debugger to process the additional information. The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. The program of the program product specifies the functions of the embodiments (including methods) of the present invention and can be embedded in various signal bearing medium. A typical signal bearing medium comprises without limitation: (i) information permanently stored in a non-writable storage medium (such as a ROM device in a computer, e.g., a CD-ROM disk which can be read by a CD-ROM drive); (ii) alterable information stored in a writable storage medium (such as a floppy disk in a floppy disk drive or a hard disk drive); and (iii) information transmitted to the computer through a communication medium such as a computer or telephone network etc., including wireless communication.

The above disclosed specific embodiments are only illustrative, because the present invention can be modified and implemented in different but equivalent ways, which are obvious to those skilled in the art having the benefits of the teaching herein. Moreover, apart from those set forth in the following claims, the details in the process flow and structure as described herein are not intended to be limiting otherwise. Therefore, the specific embodiments as described above apparently can be altered or modified, and all these changes are construed to be within the scope of the present invention as defined by the claims.

What is claimed is:

1. A method for implementing watchpoints used in debugging a computer program, comprising the steps of:
during a compilation phase of the program, generating access location information for variables in the program through data flow analysis; and
during a debugging phase of the program, implementing watchpoints for program variables as specified by a user according to the access location information for the program variables.

2. The method as recited in claim 1, wherein the access location information for a program variable comprises access location sets for the program variable, and the step of implementing watchpoints comprises setting a breakpoint at each access location in the access location sets for the program variable.

3. The method as recited claim 2, wherein the access location sets comprises a read access location set and a write access location set.

4. The method as recited in claim 3, wherein the read access location set and the write access location set are generated from DU chains or UD chains for the variable.

5. The method as recited in claim 4, wherein the step of generating comprises:
converting the DU chains or UD chains in an intermediary representation for each variable in the program into a read access instruction set and write access instruction set in the intermediary representation for the variable; and
during a code generation phase, updating the read access instruction set and write access instruction set to be a corresponding binary read access location set and write access location set.

6. The method as recited in claim 5, wherein the step of generating further comprises writing the read access instruction set and write access instruction set in the intermediary representation into a symbol table.

7. The method as recited in claim 5, wherein the step of generating further comprises writing the binary read access location set and write access location set into the binary code file of the program.

8. The method as recited in claim 6, wherein the step of writing the read access instruction set and write access instruction set in the intermediary representation into a symbol table comprises writing the read access instruction set and write access instruction set into the symbol table as an extension to a corresponding variable entry in the symbol table.

9. The method as recited in claim 5, wherein the step of implementing watchpoints for program variables as specified by the user according to the access location information for the program variables during the debugging phase of the program comprises:
reading the binary read access location set and write access location set for a specified program variable;
setting a breakpoint at each access location in the read access location set and the write access location set, and marking the breakpoint as bound to the specified program variable;
when the debugger detects a breakpoint hit, determining whether the breakpoint is marked as bound to any specified program variable; and
when the determination is YES, notifying the user that the watchpoint on the specified program variable is hit.

10. A method for generating a binary code file of a program having access location information of variables in the program which can be used for debugging from the source program through a compiler, the method comprising the steps of:
generating a read access instruction set and a write access instruction set in an intermediate representation for each variable in the program based on the results of data flow analysis;
during a code generation phase, updating the read access instruction set and write access instruction set to be a corresponding binary read access location set and a write access location set; and
writing the binary read access location set and write access location set into the binary code file of the program.

11. A system for implementing watchpoints used in debugging a computer program, comprising:
a compiler-side generation apparatus for generating access location information for variables in the program through data flow analysis; and
a debugger-side implementing apparatus for implementing watchpoints for program variables as specified by a user according to the access location information for the program variables.

12. The system as recited in claim 11, wherein the access information for a program variable comprises access location sets for the program variable, and the implementing apparatus is configured to set a breakpoint at each access location in the access location sets for the program variable.

13. The system as recited in claim 12, wherein the access location sets comprises a read access location set and a write access location set.

14. The system as recited in claim 13, wherein the generating apparatus is configured to generate the read access location set and the write access location set from DU chains or UD chains for the program variable.

15. The system as recited in claim 14, wherein the generating apparatus comprises:
a converting module for converting the DU chains or UD chains in an intermediary representation for each variable in the program into a read access instruction set and write access instruction set in the intermediary representation for the variable; and
an updating module for, during a code generation phase, updating the read access instruction set and write access instruction set to be a corresponding binary read access location set and write access location set.

16. The system as recited in claim 15, wherein the generating apparatus further comprises a write-into-symbol-table module for writing the read access instruction set and write access instruction set in the intermediary representation into a symbol table.

17. The system as recited in claim 16, wherein the generating apparatus further comprises a write-into-binary-code-file module for writing the binary read access location set and write access location set into the binary code file of the program.

18. The system as recited in claim 16, wherein the write-into-symbol-table module is configured to write the read access instruction set and write access instruction set into the symbol table as an extension to a corresponding variable entry in the symbol table.

19. The system as recited in claim 15, wherein the implementing apparatus on the debugger side comprises:
a reading module for reading the binary read access location set and write access location set for a specified program variable;
a setting module for setting a breakpoint at each access location in the read access location set and the write access location set, and marking the breakpoint as bound to the specified program variable; and
a determination module for, when the debugger detects a breakpoint hit, determining whether the breakpoint is marked as bound to any specified program variable, and for, when the determination is YES, notifying the user that the watchpoint on the specified program variable was hit.
